(19) United States
(12) Patent Application Publication
(10) Pub. No.: US 2008/0079970 A1
(43) Pub. Date: Apr. 3, 2008

(54) Printing apparatus, printing method, and printing program

(75) Inventor: Masatoshi Matsuhira, Matsumoto-Shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/906,286

(22) Filed: Oct. 1, 2007

(30) Foreign Application Priority Data
Sep. 29, 2006 (JP) 2006-267874

(51) Int. Cl. G06K 15/00

(52) U.S. Cl. 358/1.9

(57) ABSTRACT

A printing method comprising determining whether to perform a correction process on image data to be printed, calculating a correction parameter of the image data when the correction process is determined to be performed, performing the correction process on the image data based on the correction parameter calculated by the calculation unit, judging whether color conversion information corresponding to a set printing condition exists when the correction process is determined not to be performed, performing a first color conversion process based on the color conversion information when it is determined that the color conversion information exists, performing the correction process on the image data based on a preset correction parameter when it is determined that the color conversion information does not exist, performing a second color conversion process on the image data subjected to the correction process based on common color conversion information, and printing the image data subjected to the first or second color conversion process on a printing sheet.

Priority is claimed from Japanese Patent Application No. JP 2006-267874 filed on Sep. 29, 2006, which is hereby incorporated by reference in its entirety.

### BACKGROUND

1. Technical Field

The present invention relates to a printing apparatus, a printing method, and a printing program.

2. Related Art

Color printers are widely used as output apparatuses that output color image data created by image processing apparatuses such as a computer and color image pick-up apparatuses such as a digital camera.

Recently, as described in JP-A-11-008773 (Abstract and Claims), in order to naturally depict, for example, a human skin color, a printing process is performed after a correction process on the image data. In general, such a correction process is performed based on statistical information created by sampling image data of an RGB color system.

In a color printer, color image data is expressed by using a CMYK (Cyan, Magenta, Yellow, and Black) color system. However, in a digital camera, a computer, or the like, the color image data is represented by using the RGB (Red, Green, and Blue) color system. Accordingly, when the image data created by the digital camera, the computer, or the like is printed by the color printer, it is necessary to perform color system conversion. A conversion process is generally performed with reference to a look-up table that represents a correspondence relationship between the RGB color system and the CMYK color system.

In the past, even when the above-described correction process was not performed using the above-described look-up table, a special table (table for converting an image into a better-looking image) was used to make an image look better. That is, in cases where correction is to be performed and where correction is not to be performed, two types of look-up tables are used to perform a color conversion process.

However, it is required that the look-up table is prepared in accordance with the type of printing sheet, type of ink, and resolution. Accordingly, a large memory area for storing the look-up table may be unnecessarily used. Moreover, the requirement of a large memory area may increase cost.

### SUMMARY

An advantage of some aspects of at least one embodiment of the invention is that it provides a printing apparatus, a printing method, and a printing program capable of effectively performing a correction process and a color conversion process.

According to an aspect of at least one embodiment of the invention, there is provided a printing apparatus including: a determination unit that determines whether to perform a correction process on image data to be printed; a calculation unit that calculates a correction parameter of the image data when the determination unit determines to perform the correction process; a first correction unit that performs the correction process on the image data based on the correction parameter calculated by the calculation unit; a judgment unit that judges whether a color conversion information process corresponding to a set printing condition is to be performed when the determination unit determines not to perform the correction process; a first color conversion unit that performs a color conversion process based on the color conversion information when the judgment unit judges that the color conversion information exists; a second correction unit that performs the correction process on the image data based on preset correction parameters when the judgment unit judges that the color conversion information does not exist; a second color conversion unit that performs the color conversion process on the image data corrected by the first or second correction unit based on common color conversion information; and a print unit that prints the image data converted by the first or second color conversion unit on a printing sheet. For this reason, according to the above-described configuration, it is possible to provide a printing apparatus capable of effectively performing the correction process and the color conversion process.

In the printing apparatus with the above-described configuration, the first color conversion unit may perform the color conversion process for a printing conditions which are frequently used and the second color conversion unit performs the color conversion process for other printing conditions. Accordingly, it is possible to decrease a size of the color conversion information and to prevent the processing speed from being reduced.

In the printing apparatus with the above-described configuration, the second correction unit may perform the correction process to increase at least one of lightness, contrast, and chroma. Accordingly, even when the correction process is not performed, it is possible to obtain a good-looking print image.

In the printing apparatus with the above-described configuration, the second correction unit may perform the correction process by modifying a characteristic of a tone curve representing input/output characteristics. Accordingly, the image can have various advantages by changing the tone curve.

In the printing apparatus with the above-described configuration, the second correction unit may have correction parameters corresponding to the type of the printing sheet and selects the correction parameter in accordance with the printing sheet. Accordingly, even when any printing sheet is used, it is possible to obtain a good-looking print image.

In the printing apparatus with the above-described configuration, the first and second color conversion units may have a plurality of pieces of color conversion information and select the color conversion information according to the type of ink, the type of the printing sheet, and the print resolution which the print unit uses. Accordingly, even when any type of ink, any type of printing sheet, and any print resolution are selected, it is possible to obtain a good-looking print image.

According to another aspect of at least one embodiment of the invention, there is provided a printing method including the following steps: deciding whether to perform a correction process on image data, which is a print target; calculating a correction parameter of the image data when the correction process is determined to be performed; performing the correction process on the image data based on the correction parameter calculated by the calculation unit; judging whether color conversion information corresponding to a set printing condition exists when the correction process is determined not to be performed; performing a color conversion process based on the color conversion information when it is determined that the color conversion information exists; performing the correction process on the image data based on a preset correction parameter when it is determined that the color conversion information does not exist; performing the color conversion process on the image data corrected by the correction process based on common color conversion information; and printing the image data converted by the color conversion process on a printing sheet. For this reason, according to the above-described configuration, it is possible to provide the printing method by which the correction process and the color conversion process are effectively performed.

According to still another aspect of at least one embodiment of the invention, there is provided a computer-readable printing program allowing a computer to serve as: a determination unit that determines whether to perform a correction process on image data, which is a print target; a calculation unit that calculates a correction parameter of the image data when the determination unit determines to perform the correction process; a first correction unit that performs the correction process on the image data base on the correction parameter calculated by the calculation unit; a judgment unit that judges that color conversion information corresponding to a set printing condition exists when the determination unit determines not to perform the correction process; a first color conversion unit that performs a color conversion process based on the color conversion information when the judgment unit judges that the color conversion information exists; a second correction unit that performs the correction process on the image data based on a preset correction parameter when the judgment unit judges that the color conversion information does not exist; a second color conversion unit that performs the color conversion process on the image data corrected by the first or second correction unit based on common color conversion information; and a print unit that prints the image data converted by the first or second color conversion unit on printing sheet. For this reason, according to the above-described configuration, it is possible to provide the printing program capable of effectively executing the correction process and the color conversion process.

### BRIEF DESCRIPTION OF THE DRAWINGS

The invention will be described with reference to the accompanying drawings, wherein like numbers reference like elements.

FIG. 1 is a diagram illustrating an exemplary configuration of a printing apparatus according to an embodiment of the invention.

FIG. 2 is an exemplary block diagram illustrating function blocks performed in the embodiment shown in FIG. 1.

FIG. 3 is a diagram illustrating an overview of processes according to the embodiment of the invention.

FIG. 4 is a diagram illustrating an overview of process in a known method.

FIG. 5 is an exemplary flowchart illustrating the processes performed according to the embodiment shown in FIG. 1.

FIG. 6 is a diagram illustrating a correction process for every printing sheet.

FIG. 7 is a diagram illustrating an exemplary tone curve.

FIGS. 8A and 8B are diagrams explaining an overview of 3D-LUT.

### DESCRIPTION OF EXEMPLARY EMBODIMENTS

Hereinafter, an embodiment of the invention will be described with reference to the drawings.

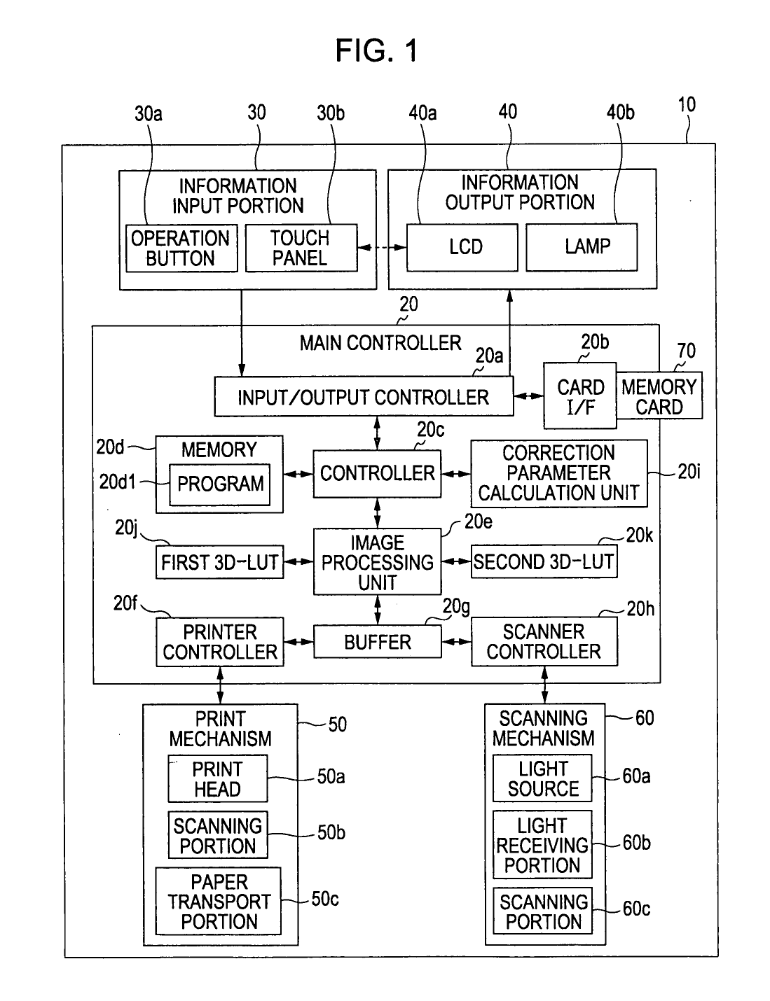

FIG. 1 is a diagram illustrating an exemplary configuration of a printing apparatus 10 according to an embodiment of the invention. A printing method and printing program according to the invention will be described with reference to an operation of the printing apparatus 10.

The printing apparatus 10 shown in FIG. 1 is a so-called multi-function printing apparatus incorporated with a scanner apparatus, a printing apparatus, and a copier apparatus. The printing apparatus 10 mainly includes a main controller 20, an information input unit 30, an information output unit 40, a printing mechanism 50, and a scanning mechanism 60.

The main controller 20 mainly includes an input/output controller 20a, a card interface (I/F) 20b, a controller 20c, a memory 20d, an image processing unit 20e, a printer controller 20f, a buffer 20g, a scanner controller 20h, a correction parameter calculation unit 20i, a first 3D-LUT (three dimensional look-up table) 20j as color conversion information, and a second 3D-LUT 20k as color conversion information. The main controller 20 controls the information output unit 40, the print mechanism 50, the scanning mechanism 60, and the like based on information input from the information input unit 30.

More specifically, the input/output controller 20a is an interface that appropriately converts a data representation format when the information input unit 30 and the information output unit 40 transmit and receive information to and from each other. The card I/F 20b reads image data from a memory card 70 or records image data onto the memory card 70 when the memory card 70 is inserted. The memory card 70 is configured by a flash memory or the like to store image data photographed by, for example, a digital camera (not shown).

The controller 20c is configured by, for example, a CPU (central processing unit) to control each unit of an apparatus based on a program 20d1 stored in the memory 20d. The image processing portion 20e performs a decoding process, an image correction process, and the like on the image data supplied from the controller 20c. The printer controller 20f controls the print mechanism 50 to print the image data or the like on a printing sheet. A buffer 20g temporarily stores the image data supplied from the printer controller 20f and temporarily stores the image data supplied from the scanner controller 20h. The scanner controller 20h controls the scanning mechanism 60 to optically read the image data printed on a document.

As a calculation unit, the correction parameter calculation unit 20i calculates a correction parameter in accordance with an instruction when an automatic correction process is set to be performed on the imager data. As a part of a first color conversion unit, the first 3D-LUT 20j and as a part of a second color conversion unit, the second 3D-LUT 20k are tables referred to at the time of converting the image data and have information for converting an RGB color system into a CMYK color system. In a case where a correction is not to be performed, the first 3D-LUT 20j is a color conversion table used when the frequently used printing conditions are set. In cases where a correction process is to be performed and where the correction process is not to be performed, the second 3D-LUT 20k is the color conversion table used when printing conditions which are not used frequently are set. A more detailed description will be made below.

The information input portion 30, which mainly includes operation buttons 30a and a touch panel 30b, creates and outputs information based on the operation of a user. The operation buttons 30a, which are buttons arranged in an operation panel or the like, generate and output information based on the operation of a user. The touch panel 30b is arranged so as to overlap an LCD (liquid crystal display) 40a. Based on information displayed on the LCD 40a, the touch panel 30b is operated so that positional information corresponding to the operated position [of what?] is output.

The information output portion 40, which mainly includes the LCD 40a and a lamp 40b, outputs information as guidance to a user. In this case, the LCD 40a is overlapped with the touch panel 30b, as described above, and displays image data or the like supplied from the controller 20c. The lamp 40b, which is arranged in the operation panel or the like, displays predetermined information to a user by being switched on and off in accordance with control of the controller 20c.

As the print unit, the print mechanism 50, which mainly includes a print head 50a, a scanning portion 50b, and a paper transport portion 50c, prints the image data supplied from the controller 20c to a printing sheet. The print head 50a, for example, appropriately ejects each color ink corresponding to CMYK from a plurality of nozzles to print an image corresponding to the printing sheet. The scanning portion 50b moves the print head 50a in a primary scanning direction (a direction perpendicular to a nozzle row of each color). The paper transport portion 50c moves the printing sheet in a secondary scanning direction (a direction parallel to a nozzle row of each color).

The scanning mechanism 60, which mainly includes a light source 60a, a light-receiving portion 60b, and a scanning portion 60c, optically reads an image printed on a document to create and output corresponding image data.

The light source 60a which is constituted by, for example, a cold-cathode tube, irradiates white light to an area to be read. The light-receiving portion 60b is irradiated by the light source 60a and is constituted by a CCD (charge coupled device) which receives light reflected by the document and converts the light into a corresponding electrical signal. The scanning portion 60c moves the light-receiving portion 60b in the secondary scanning direction (a direction perpendicular to a longitudinal direction of the light-receiving portion 60b).

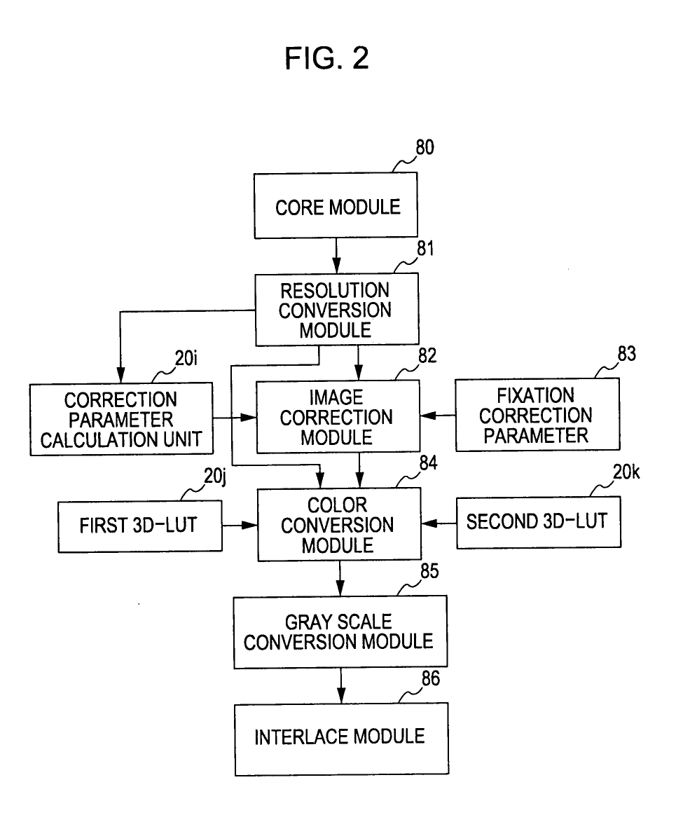

FIG. 2 is a block diagram illustrating function blocks performed in a cooperative manner with the program 20d1 as software and hardware including the controller 20c shown in FIG. 1. As shown in FIG. 2, the functions include a core module 80, a resolution conversion module 81, an image correction module 82, a preset correction parameter 83, a color conversion module 84, a gray scale conversion module 85, an interlace module 86, a correction parameter calculation portion 20i, the first 3D-LUT 20j, and the second 3D-LUT 20k.

As a determination unit and judgment unit, the core module 80 is a central module of the modules and connects each of the modules together to perform the following processes. The resolution conversion module 81 converts resolution of the image data supplied from the core module 80 into a resolution that is appropriate for a printing process to be performed by the printing mechanism 50. The correction parameter calculation portion 20i, which is the same as that shown in FIG. 1, calculates parameters when the image data is to be corrected. As a first correction unit and a second correction unit, the image correction module 82 performs a correction process on the image data based on the correction parameters supplied from the correction parameter calculating portion 20i or the preset correction parameter 83.

In a case where the correction process is not performed as a printing condition, the fixation correction parameter 83 supplies preset correction parameters stored in advance to the image correction module 82 when the frequency of use of the printing condition is not high. As a first color conversion unit and a second color conversion unit, the color conversion module 84 converts the image represented in accordance with the RGB color system to image data represented in accordance with the CMYK color system with reference to one of the first 3D-LUT 20j and the second 3D-LUT 20k. The first 3D-LUT 20j and the second 3D-LUT 20k are the same as those shown in FIG. 1 and have information (as described in detail below) that is required to perform a color conversion process. The gray scale conversion module 85 converts the image data (data having 256 gray scale levels) subjected to the color conversion process by the color conversion module 84 into image data of the number of the gray scale levels representable by the printing mechanism 50.

When the print mechanism 50 prints the image data, the interlace module 86 sorts the image data according to an order in which the print head 50a will form dots.

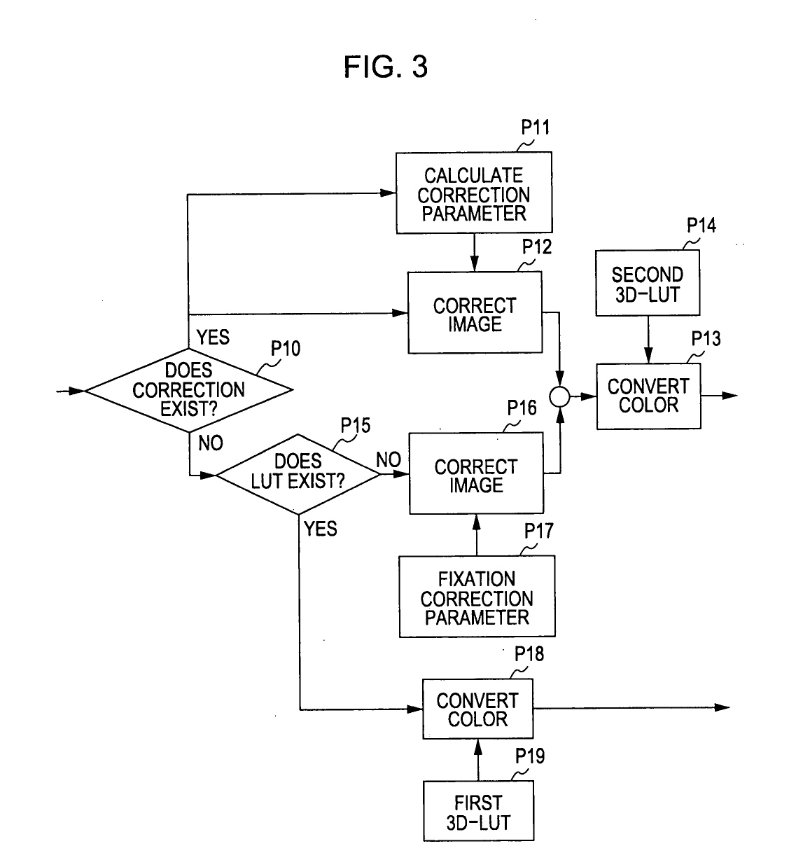

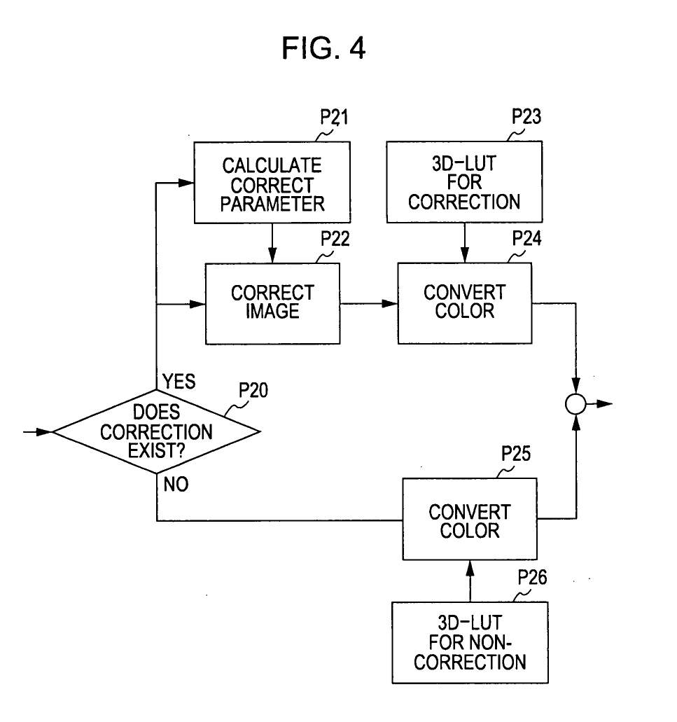

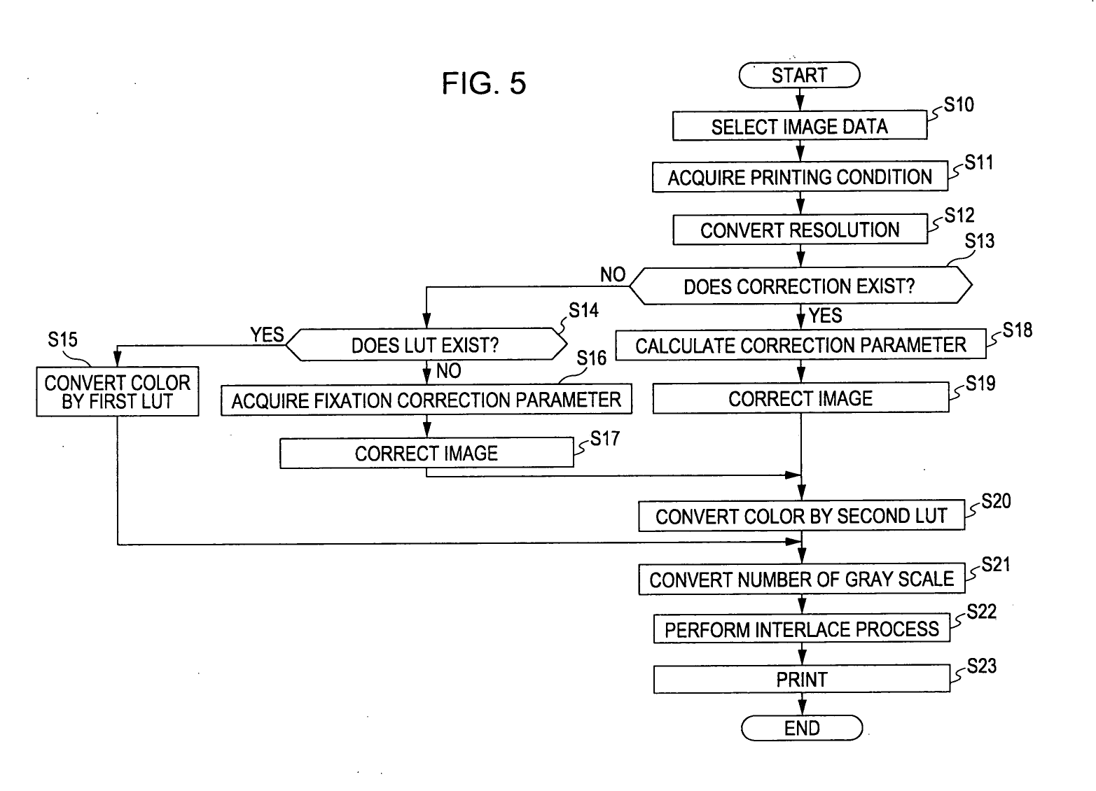

Next, processes according to the above-described embodiment will be described. Hereinafter, the processes according to the embodiment of the invention will be described with reference to FIGS. 3 and 4, and then the detailed operation will be described with reference to FIGS. 5 to 8.

The processes according to the embodiment of the invention will be described with reference to FIGS. 3 and 4. FIG. 3 is a diagram illustrating an overview of the processes according to the embodiment of the invention. As shown in FIG. 3, in the embodiment of the invention, when it is determined that image correction is to be performed (P10), the correction parameter calculation portion 20i calculates the correction parameters in accordance with the image data (P11) at the time of performing the correction process (Y), and then the image correction module 82 performs the image correction process (p12). Subsequently, the color conversion module 84 performs the color conversion process (P13) on the image data corrected by the image correction process with reference to the second 3D-LUT 20k (P14).

Alternatively, when the correction process is not to be performed, two types of process are performed depending on whether the LUT exists or not. First, a first process is a process corresponding to the frequently used printing conditions (for example, default printing conditions). In such a process, the color conversion process is performed (P18) while an image quality improvement process is performed to create a good-looking image with reference to the first 3D-LUT 20j (P19). In addition, a second process is a process corresponding to the printing conditions which are not used frequently. In such a process, after the image correction process is performed (P16) with reference to the preset correction parameter (P17), the color conversion process is performed (P13) with reference to the second 3D-LUT 20k (P14). Moreover, whether the first process is performed or the second process is performed depends on whether the corresponding LUT exists in the first 3D-LUT 20j or not.

FIG. 4 is a diagram illustrating an overview of process performed in a known method. As shown in FIG. 4, in the known method, when it is determined whether image correction is to be performed (P20), the correction parameters in accordance with the image data are calculated (P21) at the time of performing the correction process (Y), and then the image correction process is performed (P22). Subsequently, with reference to a 3D-LUT (P23), the color conversion process on the image data corrected by the image correction process is performed (P24). Alternatively, when the correction process is not to be performed, the color conversion process is performed (P25) with reference to a 3D-LUT for non-correction (P26). Moreover, referring to the 3D-LUT for the non-correction, the image quality improvement process is performed to create a good-looking image in addition to the color conversion process. As a result, it is possible to obtain a good-looking print image by using the 3D-LUT.

In the known method shown in FIG. 4, the color conversion process is performed with reference to the 3D-LUT for correction when the correction process is performed. Alternatively, the color conversion process is performed with reference to the 3D-LUT for non-correction when the correction process is not to be performed. For this reason, two types of 3D-LUTs for correction and non-correction are required. Since the 3D-LUTs are required to be prepared according to types of printing sheet, types of ink, or the like, many 3D-LUTs are required in consideration of these combinations. Accordingly, a large memory capacity is necessary.

However, in the embodiment of the invention shown in FIG. 3, a partial process (a process for the printing condition which is not used frequently) of the image quality improvement process performed by the known 3D-LUT for non-correction is substituted by the image correction process (P13) performed by the image correction module 82. Accordingly, since a common 3D-LUT can be used in the cases where correction is to be performed and where correction is not to be performed, some of the 3D-LUT for non-correction in the case shown in FIG. 4 can be omitted. Accordingly, it is possible to reduce the required memory capacity. Moreover, reduction in the processing speed can be prevented by performing the color conversion process for the frequently used printing condition. That is, compared to the case where the image correction process and the color conversion process are both performed, it is possible to shorten the time required for performance by rearranging these processes.

In this way, in the embodiment, the printing condition which is not used frequently in the 3D-LUT for image correction in the known technology is not used and is substituted by the correction process using the preset correction parameter. Accordingly, it is possible to reduce the memory capacity by omitting the 3D-LUT for the printing condition which is not used frequently. Moreover, by performing the image quality improvement process for the frequently used printing condition using the 3D-LUT, it is possible to increase the processing speed to a greater degree than for the correction process using the fixation parameter.

Next, the processes according to the embodiment of the invention will be described in detail with reference to FIG. 5. FIG. 5 is a flowchart illustrating a case where image data stored in the memory card 70 is selected to be printed according to the embodiment shown in FIG. 1. In addition, the following process is performed in a manner in which the program 20d1 stored in memory as software is executed using hardware including the controller 20c, as shown in FIG. 1.

Step S10: when a user operates the operation button 30a or the touch panel 30b to select predetermined image data stored in the memory card 70, the controller 20c acquires the image data from the memory card 70 and displays the image data on the LCD 40a. Specifically, the controller 20c acquires the image data compressed in a JPEG format from the memory card 70 and supplies the image data to the image processing portion 20e. The image processing portion 20e decodes the supplied image data by performing a Huffman decompression, an inverse quantization, an inverse DCT (discrete cosine transform), and the color conversion process (conversion from YCC to RGB). Subsequently, after the image data is thinned in accordance with a display size of the LCD 40a, the acquired image data is converted into an image signal and supplied to the LCD 40a so as to be displayed through the input/output controller 20a.

Step S11: when a user confirms a desired image with reference to the image displayed on the LCD 40a, the controller 20c displays a user interface on the LCD 40a and receives set printing conditions. That is, the controller 20c receives print resolution, a type of printing sheet, a type of ink, requirement of image correction or not, and a setting for the types. More specifically, in the case of the print resolution, the resolution of how many dots per unit length are printed is set. In general, as the resolution increases, the print image quality increases, but time required to perform a printing process tends to increase. As a print resolution, a default value of the print resolution is normally used, but a user can manually set the print resolution, if necessary. As a type of printing sheet, a type of printing sheet set in the printing apparatus 10 can be set. The type of printing sheet is required to be set as a commercial name of the printing sheet as a rule. In a case of standard printing sheets manufactured by a printer maker, “glossy paper” or “special glossy paper” can be set. In the embodiment, one of “regular paper” and “exclusive use paper” is selected. As a type of ink, a type of ink mounted in the printing apparatus 10 can be set. The type of ink recorded on a lateral surface of an ink cartridge is input. There is an ink cartridge mounting an IC chip in which information such as the type of ink or a manufacture data is stored. The printing apparatus 10 corresponds to the ink cartridge mounting the IC chip. Accordingly, if the information stored in the IC chip mounted in the ink cartridge is read, the information about the type of ink is automatically read.

For the image correction or not variable, for example, the image correction is selected between “the image correction” and “the image non-correction”. At this time, the image correction process refers to a process in which the printing apparatus 10 automatically performs the correction process based on attribute information of the image data. In addition, as the attribute information, statistical information or the like acquired by directly sampling the image data can be used. For example, PIM (print image matching) information and header information of Exif (exchangeable image file format) can be used. A manual process in which a user manually operates correction contents and directly sets the correction contents may be included. A correction non-performance refers to when the automatic correction process is not performed. In addition, the above-described input information is supplied to the core module 80.

Step S12: the resolution conversion module 81 converts the resolution of the image data selected after the process of step S10 to a resolution (hereinafter, referred to as “print resolution”) at the time when the printing mechanism 50 prints an image on the printing sheet. Specifically, the resolution conversion module 81 performs a linear interpolation to create new data between the adjacent image data when the resolution of the image data is lower than the print resolution. Alternatively, the resolution conversion module 81 thins out the image data in a fixed ratio to convert the resolution of the image data into the print resolution when the resolution of the image data is higher than the print resolution.

Step S13: the core module 80 judges whether “the image correction” is set, referring to the printing condition acquired in step S11. When the image correction is set, step S18 proceeds, and if otherwise, step S14 proceeds. For example, when the image non-correction is set, step S14 proceeds.

Step S14: the core module 80 judges whether the LUT corresponding to the printing condition exists in the first 3D-LUT 20j. When the LUT exists, step S15 proceeds, and if otherwise, step S16 proceeds. For example, when the frequently used printing condition (for example, default printing condition) is set, the corresponding LUT exists in the first 3D-LUT 20j. Accordingly, step S15 proceeds.

Step S15: the color conversion module 84 selects the 3D-LUT from the first 3D-LUT 20j in accordance with the acquired printing condition in step S11 and performs the color conversion process on the image data of which the resolution is converted in step S12 based on the selected 3D-LUT. As a result, the color conversion process is performed in accordance with the printing condition and the image data represented by the RGB color system is converted into the image data represented by the CMYK color system. Since a conversion coefficient is selected so as to also improve the image quality, the improvement (for example, improvement of contrast, lightness, or the like) of the image quality in addition to the color conversion is designed in the fist 3D-LUT 20j.

In this case, as the first 3D-LUT 20j, one LUT corresponding to a default set may be prepared or an LUT corresponding to a plurality of frequently used set (corresponding to the frequently used type of the printing sheet, type of ink, and resolution) may be prepared to select what corresponds to the set condition among these.

Before the color conversion process of the color conversion module 84 is performed, the image correction module 82 decodes the image data (Huffman decompression and the inverse quantization) when image rotation is required. Simultaneously, the image correction module 82 performs an acquisition process of rotation information (address representing a left end block of the image in the image data).

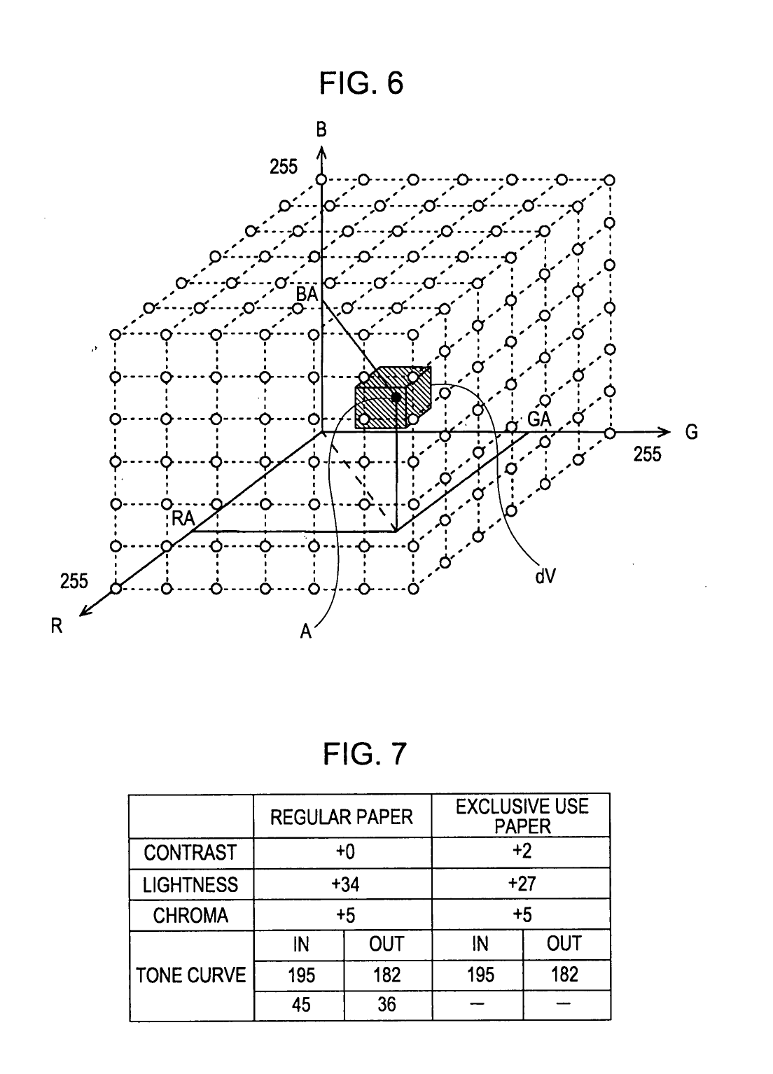

FIG. 6 is a diagram illustrating conceptually the 3D-LUT (a color conversion table). When each gray scale value of the RGB is applied to each axis of three-dimensional rectangular coordinates, each gray scale value of the RGB is in the range of 0 to 255. As shown in FIG. 6, the RGB image data can be represented as inside coordinates of a cube of which a side has a length of 255. Such a cube is called a color solid. The LUT is a numerical table in which each lattice point stores a gray scale value of each color when the color solid is subdivided in a lattice shape. Referring to the LUT, it is possible to perform the rapid color conversion process in the following manner. For example, when the gray scale values of R, G, and B convert colors represented as RA, GA, and BA, respectively, a small cube (dV) including a point A can be seen in consideration of a point A of coordinates (RA, GA, and BA) in the color solid. When reading the gray scale levels of the colors C, M, Y, and K stored in each vertex of the cube and interpolating the read gray scale levels of the colors, it is possible to calculate the gray scale values of C, M, Y, and K of the point A.

The combination of the type of ink and the printing sheet to be used in the printing process affects the printing results of the ink. Accordingly, it is desirable to perform the color conversion process with reference to an appropriate LUT in accordance with the combination of the ink and printing sheet.

As described in FIG. 6, the gray scale values of the colors stored in the lattice points are interpolated in the color conversion process and the gray scale values of C, M, Y, and K are calculated. Accordingly, as a distance between the lattice points becomes smaller or as the number of the lattice points stored in the LUT becomes more numerous, precision of the color conversion increases. In particular, in an exclusive printing sheet used when a high definition image is printed, it is desirable to use the 3D-LUT having numerous lattice points for every combination of the exclusive printing sheet and standard types of ink.

3D-LUT used only in a specific image processing apparatus may be used. That is, when a color image photographed using the image processing apparatus such as a digital camera is printed, an image having a higher quality can be printed by using the exclusive use 3D-LUT because of the following reason. That is, when the color image photographed using the image processing apparatus such as a digital camera is printed, a color of the image may be different subtly depending on types of the image processing apparatuses. The reason is because characteristics of an element detecting light of the colors R, G, and B from the image to be photographed and converting the light into the image data having the colors RGB may be different from every image processing apparatus. Similarly, a light intensity or a wavelength range of detectible light may be different depending on the type of the image processing apparatus. Accordingly, a range (gamut) of a color reproducible as the print image may be different depending on the type of the image processing apparatus. Normally, in order to reduce a difference in a characteristic of every apparatus, a color image data corrected into a standard characteristic called sRGB is used. However, in the correction process, a little correction error may be mixed or the representable gamut may be narrow. When the image processing apparatus photographing the color image is specified, it is possible to perform the color conversion so as to reproduce the right photographed colors. As a result, it is possible to print a high quality of the image.

Step S16: when the LUT corresponding to the first 3D-LUT 20j does not exist, the image correction module 82 acquires parameters corresponding to the printing conditions from the preset correction parameters 83. At this time, the preset correction parameters refer to a parameter for substituting the color conversion process performed using the 3D-LUT for non-correction shown in FIG. 4.

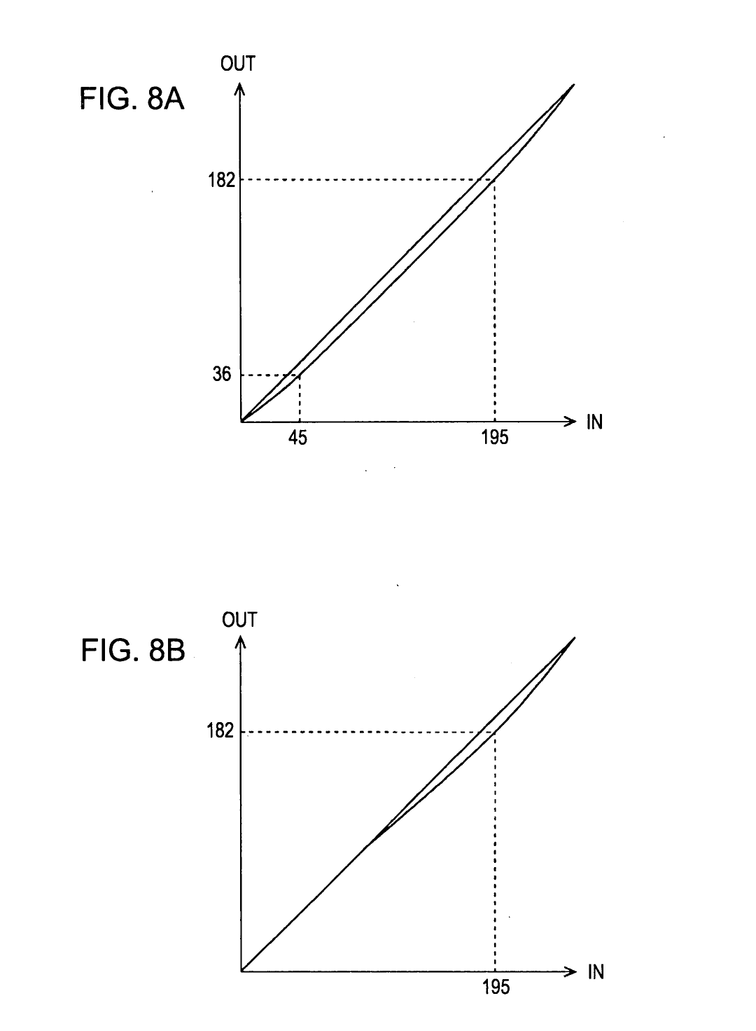

FIG. 7 is a diagram illustrating correction contents of the regular paper and the exclusive use paper. As shown in FIG. 7, in the regular paper, contrast is not changed (+0), lightness increases by “34”, and chroma increases by “5”. In addition, in a tone curve, inputs (IN) “45” and “195” are adjusted so as to be mapping to outputs (OUT) “182” and “36”. FIG. 8A shows the tone curve used in the correction of the regular paper. In FIG. 8A, a horizontal axis and a vertical axis represent input (IN) values and output (OUT) values of the gray scale levels, respectively. In addition, the tone curve representing characteristics of the input and output is a curve passing through coordinates (45, 36) and coordinates (195, 182). In this way, an image of which the brightness of an in-between portion is restrained is created.

On the other hand, in the exclusive use paper, the contrast increases by “2”, the lightness increases by “27”, and the chroma increases by “5”. In addition, in a tone curve, the input (IN) “195” is adjusted so as to be mapping to the output (OUT) “182”. FIG. 8B shows the tone curve used in the correction of the exclusive use paper. The tone curve representing the characteristics of the input and output is a curve passing through coordinates (195, 182). In this way, an image of which the brightness of an upper portion is restrained more than the in-between portion is created.

The correction contents described above is one example, but the invention is not limited to such contents.

Step S17: the image correction module 82 performs the correction process on the image data based on the preset correction parameter acquired in step S14. Specifically, the image correction module 82 performs the correction process to increase the contrast, the lightness, and the chroma based on the preset correction parameter (see FIG. 7) acquired in step S16 and adjusts the gray scale values in accordance with the tone curve shown in FIGS. 8A and 8B.

In order to increase the contrast, the correction process can be realized by converting the pixel values using the tone curve having S-shaped input/output characteristics. In order to increase the lightness, the correction process can be realized by increasing only the specified pixel values and outputting them for the entire pixels in the image, for example. In order to increase the chroma, the correction process can be performed as follows. That is, when the pixel values before the correction are denoted by R, G, and B, the pixel values after the correction are denoted by R′, G′, and B′, the brightness is denoted by Y(=0.30R+0.59G+0.11B), and a correction coefficient is denoted by a, a relationship between R′, G′, and B′ and R, G, and B is as follows:

R′=R+(R−Y)×α (1),

G′=G+(G−Y)×α (2), and

B′=B+(B−Y)×α (3).

The correction process by the tone curve can be performed based on the table having the same characteristic as the tone curve shown in FIGS. 8A and 8B. Moreover, the above-described correction process is one example, but other correction processes other than the above-described correction process may be performed or the correction process may be performed using methods other than the above-described method.

At this time, the image correction module 82 decodes the image data (Huffman decompression and the inverse quantization) when image rotation is required at the time of printing the image data. Simultaneously, the image correction module 82 performs an acquisition process of rotation information (address representing the left end block of the image in the image data).

Step S18: the correction parameter calculation portion 20i calculates the correction parameters. That is, the correction parameter calculation unit 20i performs the Huffman decompression, the inverse quantization, the inverse DCT calculation, and the color conversion process (process converting the YCC color system to RGB and HSB color systems) and thins out some of the acquired image data by performing sampling. Subsequently, the correction parameter calculation unit 20i calculates histograms on the image data subjected to the sampling, and then calculates the correction parameters based on the histograms. Specifically, the correction parameter calculation portion 20i corrects the image data so that a human skin color as a subject of the image approximates a color stored in advance.

Step S19: the image correction module 82 performs the correction process on the image data based on the correction parameters calculated in step S18. Specifically, the image correction module 82 performs the correction process on the lightness, the contrast, the chroma, and color tone of the image data based on the correction parameters calculated in step S18.

At this time, when image rotation is required at the time of printing the image data, the image correction module 82 performs an acquisition process of rotation information (address representing the left end block of the image in the image data).

Step S20: the color conversion module 84 performs the color conversion process on the image data subjected to the correction process by the preset correction parameters in step S17 and the image data subjected to the correction process based on the sampling in step S19, referring to the second 3D-LUT 20k. The second 3D-LUT 20k is subjected only to the color conversion process with no image quality improvement process, which is different than the first 3D-LUT 20j.

Step S21: the gray scale conversion module 85 decreases the number of the gray scale levels of the image data subjected to the color conversion process in step S15 or S20. That is, the image data after the color conversion process has 256 gray scale widths every color. Accordingly, the printing mechanism 50 according to the embodiment has no choice but to select one of “formation of dots” and “no formation of dots”. That is, the printing mechanism 50 according to the embodiment cannot help representing only two gray scale levels locally. For this reason, it is required that the image data having the 256 gray scale levels is converted to image data having two representable gray scale levels.

As a method of converting the number of the gray scale levels of the image data, various methods such as an error diffusion method and a systematic dither method are known. The error diffusion method is a method of diffusing an error generated by converting the number of the gray scale levels of a pixel to adjacent pixels and converting the number of the gray scale levels so as to minimize the diffusion error at the time of converting the number of the gray scale levels of each adjacent pixel. When the gray scale conversion process is performed using the error diffusion method, the gray scale conversion process is performed so as to reduce the error. As a result, the error diffusion method has an advantage in that the high-definition image can be generally obtained. The systematic dither method is a method of uniformly setting threshold values of 0 to 255 to each pixel of a matrix called a dither matrix, comparing a magnitude relation between the image data and threshold values set as the dither matrix, and forming dots on the pixel in which the image data is larger and not forming the dots on the pixel in which the threshold value is larger. The gray scale conversion module 85 performs the gray scale conversion process based on the methods.

Step S22: the interlace module 86 performs the interlace process on the image data subjected to the gray scale conversion process. That is, as described above, the printing mechanism 50 forms the dots at a proper timing to print an image while allowing the print head 50a, which ejects each color ink to perform a primary scanning process and a secondary scanning process on the printing sheet. That is, the dots may necessarily not be formed in an order of the image data. Accordingly, taking the order forming the dots into consideration in the printing mechanism 50, it is required to sort an order of transmitting the image data to the printing mechanism 50. The interlace module 86 performs the so-called interlace process.

Step S23: the image data subjected to the interlace process is temporarily stored in the buffer 20g, supplied to the printing mechanism 50 through the printer controller 20f, and then is printed on the printing sheet. That is, the printing mechanism 50 acquires the image data of one scanning line from the printer controller 20f and allows the print head 50a to eject the corresponding color ink to print the image data on the printing sheet. At this time, the scanning portion 50b allows the print head 50a to move in the primary scanning direction and the paper transport portion 50c transporting the printing sheet in the secondary scanning direction. The image data is printed on the printing sheet by repeating such processes.

As described above, according to the embodiment of the invention, the printing conditions which are not used frequently are substituted by performing the image correction process using the preset correction parameters during the image quality improvement process of the image data performed using the 3D-LUT for non-correction in the known method. Accordingly, a size of the 3D-LUT can be reduced. For this reason, it is possible to reduce a necessary amount of memory for storing the 3D-LUT. In particular, it is possible to reduce cost of the printing apparatus of a so-called stand-alone type capable of printing the image data in a manner of no connection with a host computer.

Since the image quality improvement process on the frequently used printing conditions in addition to the color conversion process is performed with reference to the first 3D-LUT 20j, it is possible to prevent the reduction of processing speed.

The above-described embodiment may be modified to various forms. For example, in the embodiment, the memory card 70 is inserted into the card I/F 20b to read the image data. However, for example, a digital camera (not shown) may be connected to the input/output controller 20a through a cable (not shown) and the image data may be read through the cable. Moreover, the table shown in FIG. 6 may be stored in a memory of the digital camera.

In the embodiment, the 3D-LUT is used as the color conversion information, but another color conversion information may be used.

In the embodiment, as the color conversion process, the RGB color system is converted into the CMYK color system. However, the invention may be applied to other color conversion processes other than the color conversion process. For example, a CMY color system may be used or a color system in which LM (light magenta) and LC (light cyan) are added to the CMYK color system may be used.

In the embodiment, the gray scale conversion module 85 converts the 256 gray scale levels into the two gray scale levels comprising the formation of a dot or no formation of a dot. However, for example, the 256 gray scale levels may be converted into four gray scale levels constituted by three dot combination of a large dot, a middle dot, and a small dot, or may be converted into other gray scale levels.

In the embodiment, in the preset correction parameters, the contrast, the lightness, and the chroma are adjusted in accordance with the type of the printing sheet and adjusted by the tone curve. However, for example, the contrast, the lightness, and the chroma may be adjusted in accordance with the type of ink or the resolution.

In the embodiment, the 3D-LUT is selected in accordance with the combination of the type of ink and the printing sheet. However, for example, the 3D-LUT may be selected in consideration of the print resolution or the like.

In the embodiment, the multi-function printing apparatus is used as one example. However, the invention may be applied to a general printing apparatus (printing apparatus connected to a person computer). Moreover, the invention may be applied to a general stand-alone printing apparatus other than the multi-function printing apparatus.

In the embodiment, the process shown in FIG. 4 is performed by the printing apparatus 10. However, for example, the process may be performed by a host computer connected to the printing apparatus 10.

The above-described processes can be executed by a computer. In this case, a program describing process contents of functions which the image processing apparatus has is supplied. The process functions are realized by executing the program using a computer. The program describing the process contents can be recorded on a computer readable media. Examples of computer readable media include a magnetic recording system, an optical disk, a magneto-optical medium, a semiconductor memory, and the like. Examples of a magnetic recording system include a hard disk drive (HDD), a flexible disk (FD), a magnetic table, and the like. Examples of an optical disk include a DVD (digital versatile disk), a DVD-RAM, a CD-ROM (compact disk ROM), a CD-R (recordable)/RW (rewritable), and the like. Examples of a magneto-optical medium include an MO (magneto-optical disk) and the like.

The program can be distributed by, for example, a portable recording medium such as a DVD or CD-ROM recording including the program. Moreover, the program stored in memory storage of a server computer can be transmitted from the server computer to other computers.

A computer executing the program stores the program recorded in the portable recording medium or transported from the server computer in memory storage. The computer reads the program from the memory storage and executes processes in accordance with the program. Alternatively, the computer can read the program from the portable recording medium and execute the processes in accordance with the program. Moreover, the computer can execute the sequentially received processes whenever the program is transmitted from the server computer.

What is claimed is:

1. A printing method comprising:
determining whether to perform a correction process on image data to be printed;
calculating a correction parameter of the image data when the correction process is determined to be performed;
performing the correction process on the image data based on the correction parameter calculated by the calculation unit;
judging whether color conversion information corresponding to a set printing condition exists when the correction process is determined not to be performed;
performing a first color conversion process based on the color conversion information when it is determined that the color conversion information exists;
performing the correction process on the image data based on a preset correction parameter when it is determined that the color conversion information does not exist;
performing a second color conversion process on the image data subjected to the correction process based on common color conversion information; and
printing the image data subjected to the first or second color conversion process on a printing sheet.

2. The printing method according to claim 1, wherein the first color conversion process is performed for a printing condition which is frequently used and the second color conversion process is performed for other printing conditions.

3. The printing method according to claim 1, wherein the correction process is performed on the image data based on a preset correction parameter when it is determined that the color conversion information does not exist in order to increase at least one of lightness, contrast, and chroma.

4. The printing method according to claim 1, wherein the correction process is performed on the image data based on a preset correction parameter when it is determined that the color conversion information does not exist by modifying a characteristic of a tone curve representing input/output characteristics.

5. The printing method according to claim 1, wherein the correction parameter is selected corresponding to the type of the printing sheet.

6. The printing method according to claim 1, wherein the color conversion is selected information depending on at least one of the type of ink, the type of the printing sheet, and the print resolution which the print unit uses.

7. A computer-readable printing program allowing a computer to serve as:
a determination unit that determines whether to perform a correction process on image data, which is a print target;
a calculation unit that calculates a correction parameter of the image data when the determination unit determines to perform the correction process;
a first correction unit that performs the correction process on the image data based on the correction parameter calculated by the calculation unit;
a judgment unit that judges that color conversion information corresponding to a set printing condition exists when the determination unit determines not to perform the correction process;
a first color conversion unit that performs a color conversion process based on the color conversion information when the judgment unit judges that the color conversion information exists;
a second correction unit that performs the correction process on the image data based on a preset correction parameter when the judgment unit judges that the color conversion information does not exist;
a second color conversion unit that performs the color conversion process on the image data corrected by the first or second correction unit based on common color conversion information; and
a print unit that prints the image data converted by the first or second color conversion unit on a printing sheet.

8. The printing method according to claim 1, wherein the correction process step is performed for a printing condition which is frequently used and the color conversion process step is performed for other printing conditions.

9. The printing program according to claim 7, wherein the first color conversion unit performs the color conversion process for a printing condition which is frequently used and the second color conversion unit performs the color conversion process for other printing conditions.

10. The printing method according to claim 1, wherein common color conversion information is used when the determination unit determines to perform a correction process and when the determination unit determines not to perform a correction process.
